(19) United States
(12) Patent Application Publication
(10) Pub. No.: US 2024/0333373 A1
(43) Pub. Date: Oct. 3, 2024

(54) RELAYING FRAMES BETWEEN DEVICES USING A RELAY DEVICE WITH LOWER MEDIA ACCESS CONTROL FUNCTIONS

(71) Applicant: NXP USA, Inc., Austin, TX (US)

(72) Inventors: Kiseon Ryu, San Diego, CA (US); Liwen Chu, San Ramon, CA (US); Rui Cao, Sunnyvale, CA (US); Huizhao Wang, San Jose, CA (US); Hongyuan Zhang, Fremont, CA (US)

(21) Appl. No.: 18/622,664

(22) Filed: Mar. 29, 2024

Related U.S. Application Data
(60) Provisional application No. 63/493,045, filed on Mar. 30, 2023.
(60) Provisional application No. 63/498,914, filed on Apr. 28, 2023.
(60) Provisional application No. 63/520,479, filed on Aug. 18, 2023.
(60) Provisional application No. 63/609,275, filed on Dec. 12, 2023.

(51) Int. Cl. H04B 7/155; H04L 1/1607; H04L 5/00; H04W 74/0816

(52) U.S. Cl. CPC H04B 7/15507; H04L 1/1621; H04L 5/0055; H04W 74/0816

(57) ABSTRACT

Embodiments of relay device, communications system and method are disclosed. In an embodiment, a relay device comprises a wireless transceiver to receive and transmit frames, and a controller operably coupled to the wireless transceiver to process the frames, wherein the controller is configured to receive a frame from the transmitter device, perform a relay operation to relay the frame from the transmitter device to the destination device, wherein the relay device is configured to perform the relay operation using only lower MAC functions, and transmit the frame from the transmitter device to the destination device.

### CROSS-REFERENCE TO RELATED APPLICATIONS

This application is entitled to the benefit of U.S. Provisional Patent Application Ser. No. 63/493,045, filed on Mar. 30, 2023, U.S. Provisional Patent Application Ser. No. 63/498,914, filed on Apr. 28, 2023, U.S. Provisional Patent Application Ser. No. 63/520,479, filed on Aug. 18, 2023, and U.S. Provisional Patent Application Ser. No. 63/609,275, filed on Dec. 12, 2023, which are incorporated herein by reference.

### BACKGROUND

In some situations, a direct link between a target station (STA) and a destination STA may result in low SNR, which may not support the desired Modulation and Coding Scheme (MCS) and/or throughput. In these situations, one or more relay devices may be used to decode and retransmit frames between the source and destination STAs. However, the use of relay devices may introduce challenges, such as multi-hop channel access delay, degraded end-to-end quality of service (QOS) and complex relaying protocol.

### SUMMARY

Embodiments of relay device, communications system and method are disclosed. In an embodiment, a relay device comprises a wireless transceiver to receive and transmit frames, and a controller operably coupled to the wireless transceiver to process the frames, wherein the controller is configured to receive a frame from the transmitter device, perform a relay operation to relay the frame from the transmitter device to the destination device, wherein the relay device is configured to perform the relay operation using only lower MAC functions, and transmit the frame from the transmitter device to the destination device.

In an embodiment, the controller is configured to transmit a first block acknowledgement frame to the transmitter device, wherein the first block acknowledgement frame includes a block ack information indicating which MAC protocol data unit (MPDU) is successfully received by the relay device, and transmit a second frame to a destination device, wherein the second frame includes an MPDU based on at least one MPDU in the first frame that is successfully received from the relay device.

In an embodiment, the controller is further configured to receive a second block acknowledgement frame from the destination device, wherein the second block acknowledgement frame includes a block ack information indicating which MPDU of the second frame is successfully received by the destination device, and transmit a third block acknowledgment frame to the transmitter device, wherein the third block acknowledgment frame includes a block ack information of the second block acknowledgement frame received from the destination device.

In an embodiment, the lower MAC functions include MAC protocol data unit (MPDU) processing and block acknowledgement processing, and the upper MAC functions include security processing, and sequence number and/or packet number processing.

In an embodiment, for a downlink, an address information of the destination device is included in an additional MAC control header of the frame by the transmitter device, wherein the address information is an association identifier of the destination device and the additional MAC control header is an aggregated control field.

In an embodiment, for an uplink, an address information of the relay device is included in an additional MAC control header of the frame by the relay device, wherein the address information is an association identifier of the relay device and the additional MAC control header is an aggregated control field.

In an embodiment, a time period is allocated to the relay device so that the controller can relay a frame to the destination device after receiving the frame from the transmitter device during the allocated time within a Transmit opportunity (TXOP).

In an embodiment, the controller is configured to receive, during a separate Transmit opportunity (TXOP), a retransmitted MAC protocol data unit (MPDU) that has not been successfully relayed to the destination device during a first TXOP.

In an embodiment, when the transmitter device is an ultra-high reliability (UHR) station and the destination device is an access point (AP), a MAC address of the AP is used to generate group keys, and when the transmitter device is a non-UHR station and the destination device is an AP, a MAC address of the relay device is used to generate group keys.

In an embodiment, the controller is configured to extend a Transmit opportunity (TXOP) by modifying a duration field in a frame or by using triggered TXOP sharing.

In an embodiment, the controller is configured to include an extended duration in a Request-to-Send (RTS) frame to the destination device for Transmit opportunity (TXOP) protection or use triggered TXOP sharing (TXS) for TXOP protection.

In an embodiment, the controller is configured to receive frames from the transmitter or destination device that has initiated a cascaded sounding procedure for a link between the transmitter device to the relay device or a link between the relay device and the destination device.

In an embodiment, when the transmitter device transmits more than one frame to the relay device in a Transmit opportunity (TXOP), the controller forwards one or more of the received frames (a) when the relay device receives a last buffered from the transmitter device, (b) after sending an acknowledgement frame or a block acknowledgment frame, or (c) based on an indication in a MAC header.

In an embodiment, the controller is configured to receive, from the transmitter device, a modified block acknowledgement request (BAR) frame or a modified multi-user block acknowledgement request (MU-BAR) frame that includes a source address (SA) field or a destination address (DA) field.

In an embodiment, the controller is configured to relay a multi-user Request-to-Send (MU-RTS) triggered Transmit opportunity (TXOP) sharing (TXS) trigger frame to the destination device.

In an embodiment, a method of relaying frames from a transmitter device to a destination device through a relay device comprises receiving a frame from the transmitter device at the relay device, performing a relay operation at the relay device to relay the frame from the transmitter device to the destination device, wherein the relay device is configured to perform the relay operation using only lower MAC functions, and transmitting the frame from the transmitter device to the destination device by the relay device.

In an embodiment, the method further comprises transmitting a first block acknowledgement frame to the transmitter device from the relay device, wherein the first block acknowledgement frame includes a block acknowledgement information indicating which MAC protocol data unit (MPDU) is successfully received by the relay device and wherein the frame transmitted to the destination device from the relay device includes an MPDU based on at least one MPDU in the frame that is successfully received from the relay device.

In an embodiment, the method further comprises receiving a second block acknowledgement frame from the destination device at the relay device, wherein the second block acknowledgement frame includes a block acknowledgement information indicating which MPDU of the frame is successfully received by the destination device, and transmitting a third block acknowledgment frame to the transmitter device, wherein the third block acknowledgment frame includes a block acknowledgement information of the second block acknowledgement frame received from the destination device.

In an embodiment, the lower MAC functions include MAC protocol data unit (MPDU) processing and block acknowledgement processing, and the upper MAC functions include security processing, and sequence number and/or packet number processing.

In an embodiment, a communications system comprises a transmitter device configured to perform lower media access control (MAC) functions and upper MAC functions, a destination device configured to perform the lower MAC functions and the upper MAC functions, and a relay device operably coupled to the transmitter and destination devices, the relay device being configured to perform a relay operation to relay a first frame from the transmitter device to the destination device, wherein the relay device is configured to perform the relay operation using only the lower MAC functions.

Other aspects in accordance with the invention will become apparent from the following detailed description, taken in conjunction with the accompanying drawings, illustrated by way of example of the principles of the invention.

### BRIEF DESCRIPTION OF DRAWINGS

FIG. 1 depicts a communications system for wireless communications that can be used in embodiments of the invention.

FIG. 2 illustrates the media access control (MAC) functions of a transmitter station (STA), a relay STA and a destination STA in accordance with an embodiment of the invention.

FIG. 3A illustrates a downlink (DL) relay procedure of the communications system in accordance with an embodiment of the invention.

FIG. 3B illustrates an uplink (UL) relay procedure of the communications system in accordance with an embodiment of the invention.

FIG. 4 illustrates Transmit opportunity (TXOP) sharing mechanism for relay operation of the communications system in accordance with an embodiment of the invention.

FIG. 5 illustrates a 1^{st} hop frame that was not successfully relayed to the destination STA during relay TXOP 1 being retransmitted by the transmitter STA during relay TXOP 2 in accordance with an embodiment of the invention.

FIG. 6 illustrates different information that can be included in a relay frame in accordance with an embodiment of the invention.

FIG. 7 illustrates an example of a relay A-Control field, which includes a hop subfield, a Direction subfield and an Association Identifier (AID) subfield.

FIG. 8A illustrates a Clear-to-Send (CTS) with the modified duration and a block acknowledgement (BA) with the modified duration in accordance with an embodiment of the invention.

FIG. 8B illustrates a multi-user Request-to-Send (MU-RTS) triggered Transmit opportunity (TXOP) sharing (TXS) trigger from an AP to the relay device and (MU-RTS TXS or Basic) trigger from the relay device to a non-AP STA in accordance with an embodiment of the invention.

FIG. 9 illustrates a first sounding sequence from an AP to the relay device and a second sounding sequence from the relay device to a non-AP STA in accordance with an embodiment of the invention.

FIG. 10A illustrates a CTS frame being transmitted from the relay STA to an AP after the relay STA received the first MU-RTS TXS Trigger frame from the AP, and a second MU-RTS TXS Trigger frame being transmitted from the relay STA to a destination STA in accordance with an embodiment of the invention.

FIG. 10B illustrates an AP performing a PIFS recovery or a backoff procedure in accordance with an embodiment of the invention.

FIG. 10C illustrates a QoS Null frame being transmitted from the relay STA to an AP in accordance with an embodiment of the invention.

FIG. 11 depicts a wireless device in accordance with an embodiment of the invention.

FIG. 12 illustrates a flow diagram of a method of relaying frames from a transmitter device to a destination device through a relay device in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

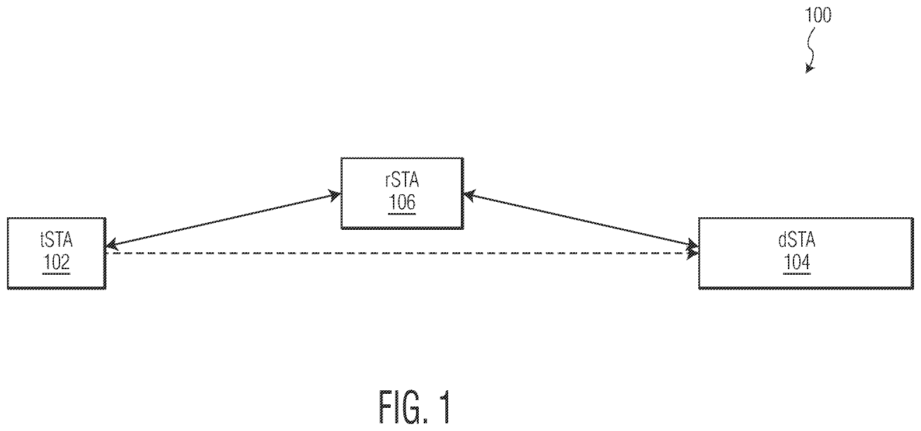

FIG. 1 depicts a communications system 100 for wireless (e.g., WiFi) communications that can be used in embodiments of the invention. In the embodiment depicted in FIG. 1, the communications system includes a transmitter station (tSTA) 102, a destination station (dSTA) 104 and a relay station (rSTA) 106. In other embodiments, the communications system may include multiple relay stations that function in a similar way as the relay station 106. The communications system 100 can be used in various applications, such as industrial applications, medical applications, computer applications, and/or consumer or enterprise applications. In some embodiments, the communications system may be a wireless communications system, such as a wireless communications system compatible with an IEEE 802.11 protocol. For example, communications system may be a wireless communications system compatible with an IEEE 802.11bn protocol. Various iterations of the 802.11 specification may be referred to herein.

In the embodiment depicted in FIG. 1, each of the tSTA 102 and dSTA 104 may be an access point (AP) or a non-AP station (STA). As an AP, the tSTA 102 or dSTA 104 may be implemented in hardware (e.g., circuits), software, firmware, or a combination thereof. The AP may be fully or partially implemented as an integrated circuit (IC) device. In some embodiments, the AP may be a wireless AP compatible with at least one WLAN communications protocol (e.g., at least one IEEE 802.11 protocol). In some embodiments, the AP may include at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver.

As a non-AP STA, the tSTA 102 or dSTA 104 may be implemented in hardware (e.g., circuits), software, firmware, or a combination thereof. The non-AP STA may be fully or partially implemented as an IC device. For example, the non-AP STA may be implemented in a laptop, a desktop personal computer (PC), a mobile phone, or other communications device that supports at least one WLAN communications protocol. The non-AP STA may be a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the non-AP STA may include at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver.

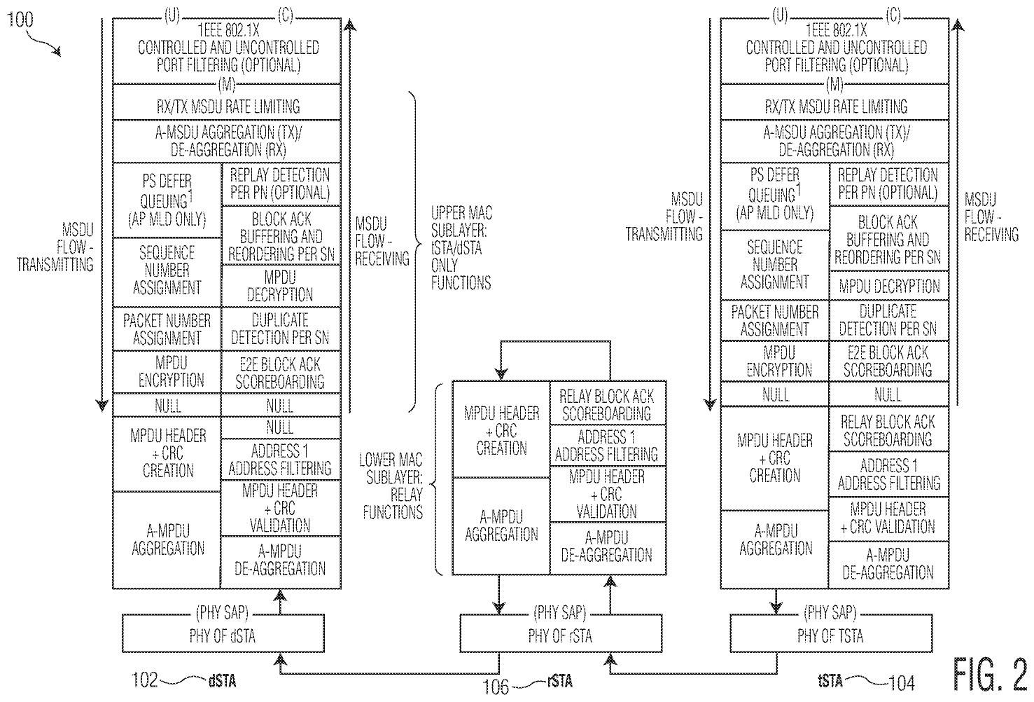

FIG. 2 illustrates the media access control (MAC) functions of the transmitter STA 102, the relay STA 106 and the destination STA 104 in accordance with an embodiment of the invention. As illustrated in FIG. 2, the relay device (i.e., the rSTA) involves only the lower media access control (MAC) functions, which includes aggregate MAC protocol data unit (A-MPDU) processing and other optional functions, such as Relay Block Acknowledgement Scoreboarding and address filtering. The A-MPDU processing may include MAC protocol data unit (MPDU) header and cyclic redundancy check (CRC) creation, A-MPDU aggregation, MPDU header and CRC validation and A-MPDU de-aggregation. This is similar to per-link functions in the Extremely High Throughput Multi-Link (EHT ML) framework. The lower MAC relay of the relay device provides hop-by-hop block acknowledgement via relay link and the end-to-end (E2E) security/sequence number (SN) processing. Similar to any other STA, the relay device includes a physical layer.

The transmitter device (i.e., the tSTA) 102 and the destination device (i.e., dSTA) 104 involve both the upper MAC functions and the lower MAC functions. The upper MAC functions include security process, which may include MPDU encryption and decryption, SN generation/reordering, such as SN assignment, duplicate detection per SN and Block Acknowledgement buffering and reordering per SN, and other functions, such as E2E Block Acknowledgement Scoreboarding, IEEE 802.1X controlled and uncontrolled point filtering, receive/transmit (RX/TX) MAC Service Data Unit (MSDU) rate limiting, Aggregate MAC Service Data Unit (A-MSDU) aggregation (TX)/de-aggregation (RX), Packet Switching (PS) defer queuing (Access Point Multi-Link Device (AP MLD) only), and replay detection per packet number (PN). The lower MAC functions of these devices are same as the lower MAC functions of the rSTA. These upper and lower MAC functions are similar to Multi-Link Device (MLD) functions with upper MAC functions and lower MAC functions in the EHT ML framework. Both tSTA and dSTA include a physical layer.

The overall downlink (DL)/uplink (UL) relay procedure for the rSTA 106 is as follows. The rSTA decodes and forwards MPDU or A-MPDU ((A-) MPDU), which is successfully received from a source or transmitter device, to a destination device within a Transmit Opportunity (TXOP) (a.k.a. relay TXOP). The rSTA may transmit Block Acknowledgement (BA)/Acknowledgement (Ack) message back to the source device after successfully receiving a frame. For DL relay, the source device and the destination device are an AP and a non-AP STA, respectively, and vice-versa for UL relay. The relay device can empty the Rx/Tx buffer after the relay TXOP.

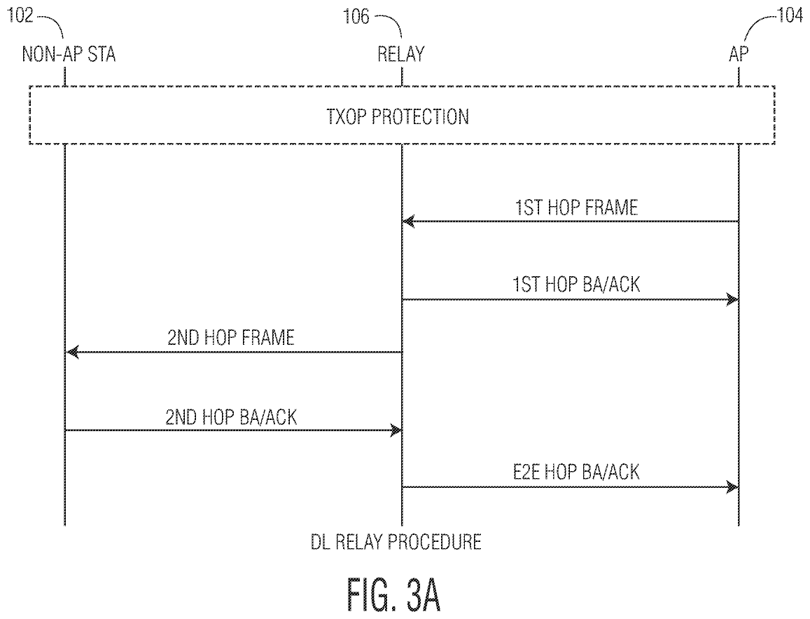

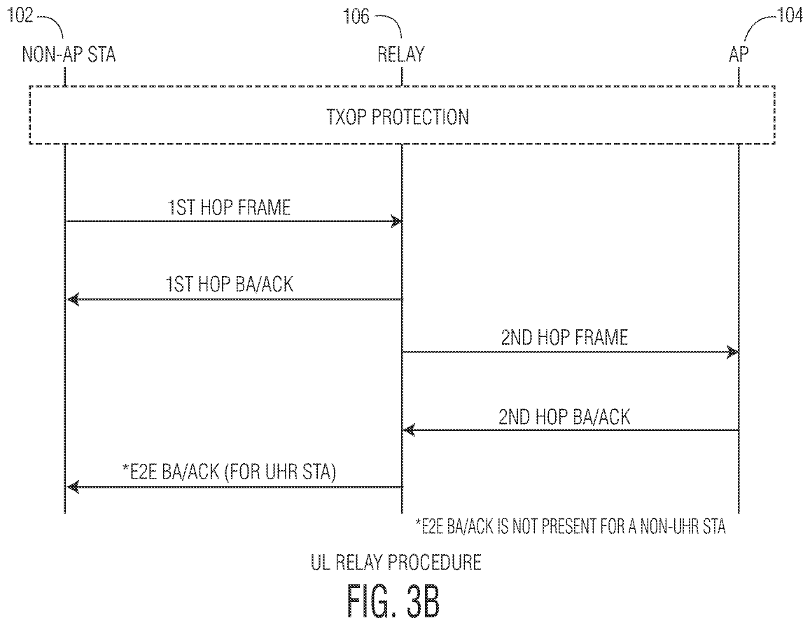

FIG. 3A illustrates a DL relay procedure of the communications system 100 in accordance with an embodiment of the invention. As shown in FIG. 3A, a 1^{st} hop frame is transmitted from the AP 104 to the relay device 106. In response, a 1^{st} hop BA/Ack is transmitted back to the AP from the relay device. A 2^{nd} hop frame is then transmitted from the relay device to the non-AP STA 102. In response, a 2^{nd} hop BA/Ack is transmitted back to the relay device from the non-AP STA. An E2E BA/Ack is then transmitted to the AP from the relay device.

FIG. 3B illustrates an UL relay procedure in accordance with an embodiment of the invention. As shown in FIG. 3B, a 1^{st} hop frame is transmitted from the non-AP STA 102 to the relay device 106. In response, a 1^{st} hop BA/Ack is transmitted back to the non-AP STA from the relay device. A 2^{nd} hop frame is then transmitted from the relay device to the AP 104. In response, a 2^{nd} hop BA/Ack is transmitted back to the relay device from the AP. An E2E BA/Ack is then transmitted to the non-AP STA from the relay device.

In a separate TXOP, the source device may retransmit any failed MPDU to the destination device through the relay device 106, based on the end-to-end BA frame forwarded by the relay device.

In some embodiments, the rSTA 106 may need to perform Enhanced Distributed Channel Access (EDCA) channel access for relaying frames after receiving 1^{st} hop frame, outside of the TXOP. This requires Tx/Rx buffer management for relay operation beyond a TXOP, which may incur additional complexity to the rSTA implementation.

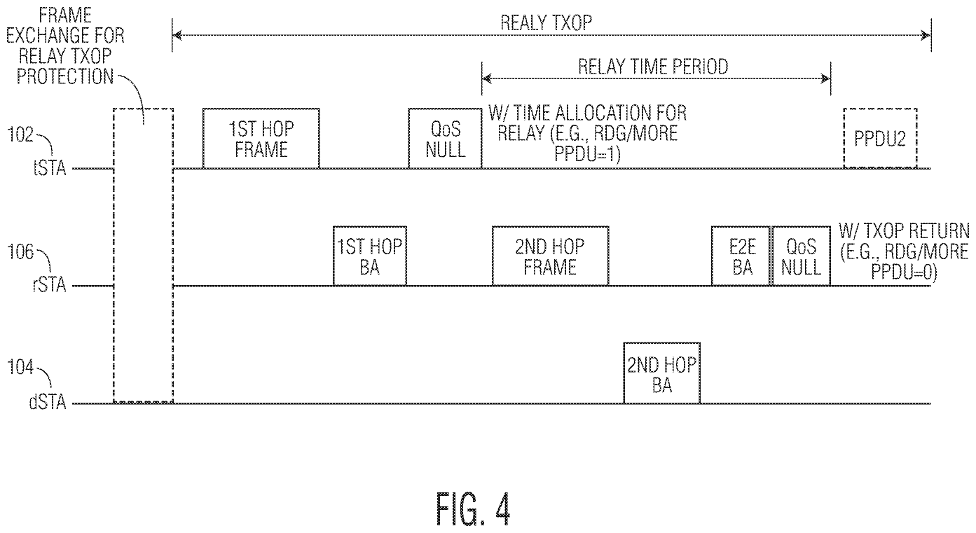

In order to resolve this issue, TXOP sharing mechanism for relay operation can be considered. A TXOP holder (i.e., the tSTA 102) may exchange frames with the rSTA and with the dSTA 104 for TXOP protection (e.g., Request-to-Send (RTS)/CTS, MU-RTS/CTS). The tSTA may allocate a time period to the rSTA so that the rSTA can relay a frame to the dSTA after receiving the frame from the tSTA during the allocated time within the TXOP. The MU-RTS TXS Trigger frame or a High Efficiency (HE) variant High Throughput (HT) Control field (e.g., Reverse Direction Grant (RDG)/More PPDU subfield in the Contention Aware Scheduler (CAS) Control subfield set to 1 or a new HE variant HT Control field) can be used to allocate a time period for the rSTA to relay a frame to the dSTA within a TXOP. An HE variant HT Control field (e.g, RDG/More PPDU subfield in the CAS Control subfield set to 0 or a new HE variant HT Control field) can be used for the rSTA to return the allocated time to the tSTA when completing frame. This is illustrated in FIG. 4, which shows that after frame exchange for relay TXOP protection, a relay time period is allocated within a relay TXOP in accordance with an embodiment of the invention.

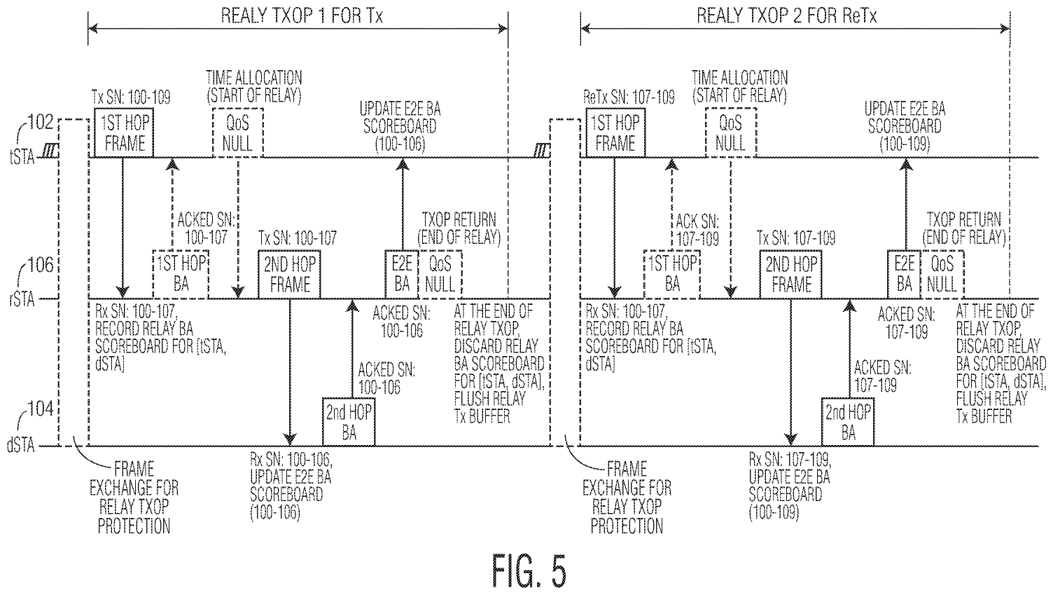

In an embodiment, retransmission of frame for relay can be done in a separate TXOP. Based on the end-to-end BA information, the tSTA 102 may retransmit MPDU(s) that has not successfully relayed to the dSTA 104 in a separate TXOP. The rSTA 106 may discard the relay BA scoreboard and the relay Tx buffer after the TXOP. Time period for relay may be allocated to the rSTA 106 and/or it may be returned from the rSTA to the tSTA, during a relay TXOP. 1^{st} hop BA frame may or may not be transmitted by the rSTA in response to a 1^{st} hop frame depending on the optional implementation (e.g., relay BA scoreboard at a tSTA and at a dSTA). This is illustrated in FIG. 5, which shows a 1^{st} hop frame that was not successfully relayed to the dSTA 104 during relay TXOP 1 being retransmitted by the tSTA 102 during relay TXOP 2 in accordance with an embodiment of the invention.

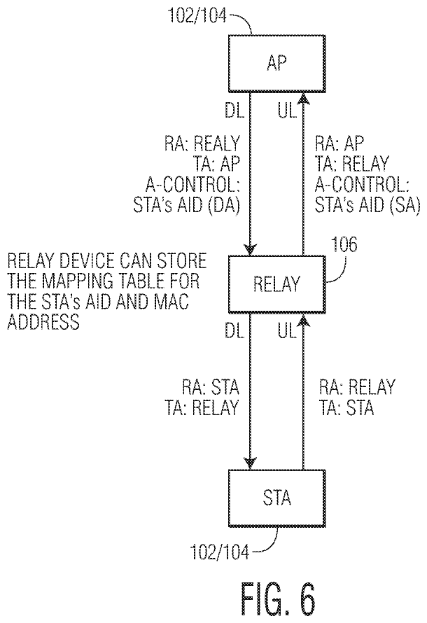

For a relay operation, at least three address information should be indicated in a relayed frame, such as the receiver address (RA), the transmitter address (TA), and the source address (SA)/destination address (DA). Ist hop frame should indicate the RA (e.g., relay device), the TA (e.g., AP for DL, non-AP STA for UL) and the DA (e.g., non-AP STA for DL, AP for UL). 2^{nd} hop frame should indicate the RA (e.g., non-AP STA for DL, AP for UL), the TA (e.g., relay device) and the SA (e.g., AP for DL, non-AP STA for UL). In order to satisfy these requirements, in an embodiment, a relay device stores the non-AP STA's address information (e.g., mapping of the Association Identifier (AID) and the MAC address) that can be relayed. Additional address information (i.e., SA/DA) can be indicated in an additional MAC control header, e.g., in the A-Control field. The AID of the non-AP STA (as in the source address or the destination address) can be included in the MAC header of the 1 st hop and/or the 2^{nd} hop frame. Additional address information for the AP (i.e., the SA for DL, and the DA for UL) may not be included in the relayed frame. The relay device can update the RA/TA fields and the additional address (SA/DA) in the A-Control field when relaying the frame, based on the additional address information indicated in the A-Control field of the received frame and the stored non-AP STA's AID/MAC address mapping information. This is illustrated in FIG. 6, which shows different information that can be included in a relay frame in accordance with an embodiment of the invention.

In an embodiment, a relay A-Control field can be included in the relayed frame with the following information:
(1) the Hop subfield: (a) 0: 1^{st} Hop Tx, (b) 1: 2^{nd} Hop Tx;
(2) the Direction subfield: (a) 0: Downlink, (b) 1: Uplink; and
(3) the AID subfield: (a) if the Hop subfield is set to 0 and the Direction subfield is set to 0, the AID subfield is set to a non-AP STA's AID that is a destination device; (b) if the Hop subfield is set to 1 and the Direction subfield is set to 1, the AID subfield is set to a non-AP STA's AID that is a source device.

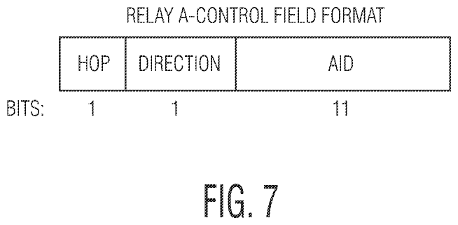

An example of a relay A-Control field is illustrated in FIG. 7, which shows the hop subfield, the Direction subfield and the AID subfield in accordance with an embodiment of the invention.

In an embodiment, the Hop subfield and the Direction subfield can be replaced with 1 bit indication indicating the AID for a non-AP STA that is for either a source device or a destination device depending on the direction of the relay operation. The AID subfield can be defined with a 9- or 8-bits length subfield indicating its least significant bit (LSB) of a non-AP STA's AID.

Similar to seamless roaming architecture (e.g., AP MLD and Roaming AP MLD), an AP and the relay device 106 can share the same AP MLD MAC address so that the end devices (i.e., the AP and an associated non-AP STA) can generate security keys, based on AP MLD MAC address and Non-AP MLD MAC address for encryption and integrity protection for the frame to be relayed. All the security processing can be performed by the end devices, and the relay device does not get involved in the security processing. Security key update may not be needed when the communication link is changed between the direct link (i.e., AP to STA) and the relay link (i.e., AP to Relay to STA) for an ultra-high reliability (UHR) STA. In an embodiment, when a non-UHR STA is associated with an AP through the relay device, the security keys can be generated based on Relay MAC address and STA MAC address by the AP and the non-AP STA for security processing. When relaying the frame, MAC header protection and MAC control frame protection can be disabled.

When a UHR STA establishes a relay link with an AP through the relay device 106, security keys used for encryption and/or integrity protection of an individually addressed frame (e.g., Pairwise Transient Key (PTK), Pairwise Master Key (PMK), etc.) between the UHR STA and the AP and group keys (e.g., Group Temporal Key (GTK), Integrity GTK (IGTK), Beacon IGTK (BIGTK), etc.) may be generated. To generate security keys, the UHR STA affiliated with a non-AP MLD and the AP affiliated with an AP MLD uses Non-AP MLD MAC address and AP MLD MAC address. To generate group keys, the AP MAC address is used.

When a non-UHR STA is associated with an AP through the relay device 106, security keys used for encryption and/or integrity protection of an individually addressed frame (e.g., PTK, PMK, etc.) between the non-UHR STA and the AP through the relay device and group keys (e.g., GTK, IGTK, BIGTK, etc.) may be generated. To generate security keys, STA MAC address and relay device MAC address are used. To generate group keys, the relay device MAC address is used.

In an embodiment, when a non-UHR STA is associated with an AP through the relay device 106, an AP may transmit a group addressed frame (e.g., a group addressed frame encrypted by GTK, IGTK, BIGTK, etc.) twice (i.e., one for non-AP STAs associated with the AP and the other for non-UHR STA associated with the AP through the relay device).

The relay device 106 may forward a management frame received from an unassociated non-AP STA to an AP for UL, and vice-versa for DL, for the non-AP STA's association procedure. To relay a management frame for an unassociated non-AP STA, a source address and/or a destination address for the unassociated non-AP STA's MAC address can be included in at least one of the following:

(1) a new element of the management frame.

(2) an additional MAC header of the management frame.

For example, for 1^{st} hop UL transmission sent from an unassociated STA to the relay device, an individually addressed MAC management frame can contain MAC header (RA: Relay, TA: Non-AP STA), Frame body, and frame check sequence (FCS). For 2^{nd} hop UL transmission sent from the relay device to an AP, an individually addressed MAC management frame can contain MAC header 1 (RA: AP, TA: Relay, etc.), MAC header 2 (RA: Relay, TA: Non-AP STA, etc.), Frame body, and FCS. The TA field of the MAC header 2 may be set to a source address (e.g., the non-AP STA MAC address) in the 2^{nd} hop UL management frame. Contents of the MAC header 1 and the MAC header 2 except the RA and the TA fields (e.g., Frame Control field, Duration/ID field, etc.) can be the same.

For 1^{st} hop DL transmission sent from the AP to the relay device 106, an individually addressed MAC management frame can contain MAC header 1 (RA: Relay, TA: AP, etc.), MAC header 2 (RA: Non-AP STA, TA: Relay, etc.), Frame body, and FCS. The RA field of the MAC header 2 may be set to a destination address (e.g., the non-AP STA MAC address) in the 1^{st} hop DL management frame. Contents of the MAC header 1 and the MAC header 2 except the RA and the TA fields (e.g., Frame Control field, Duration/identification (ID) field, etc.) can be the same. For 2^{nd} hop DL transmission sent from the relay device to the unassociated STA, an individually addressed MAC management frame can contain MAC header (RA: Non-AP STA, TA: Relay, etc.), Frame body, and FCS

In an embodiment, for relaying an individually addressed management frame for an associated STA, the additional address information (e.g., SA/DA of the non-AP STA) can be included in an A-Control field, or in the new element or in the additional MAC header of the management frame.

A non-UHR STA does not support E2E BA, Relay TXOP protection, and Announcement info of the relay device 106 in a Beacon/Probe Response frame sent by an AP. It is noted here that the non-UHR STA can act as being associated with the relay device 106 not with the AP.

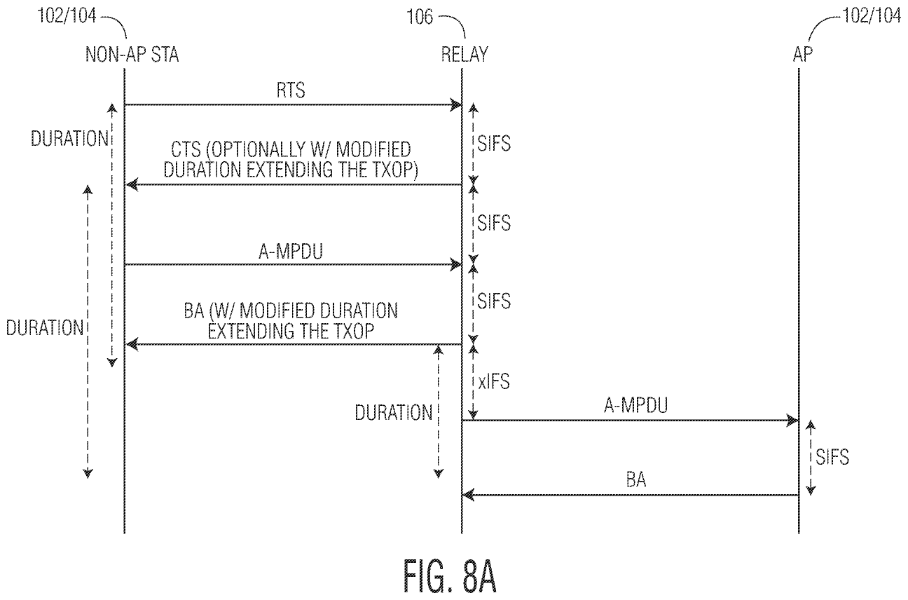

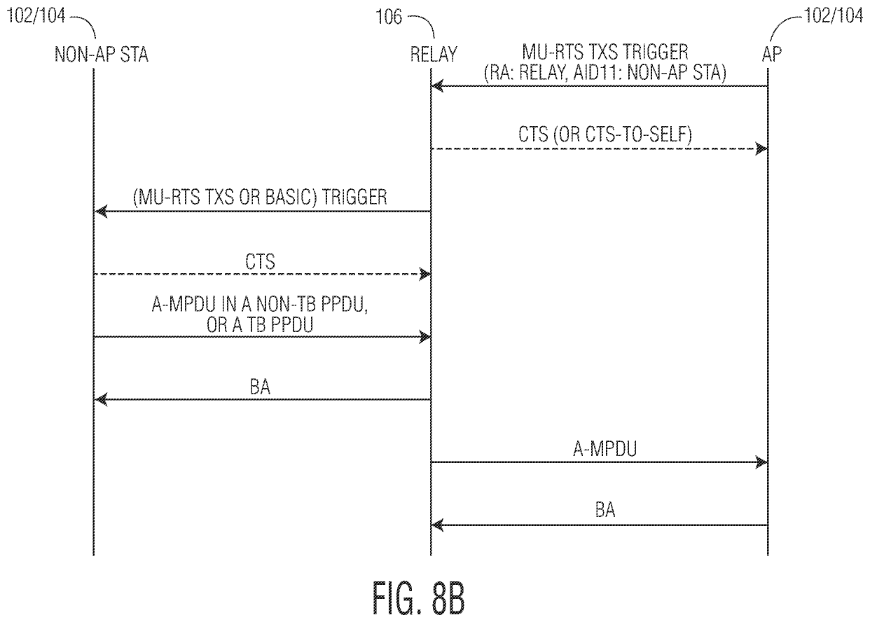

For UL relay with a non-AP STA (e.g., non-UHR STA), the relay device 106 may extend a TXOP by modifying the Duration field in a frame (e.g., CTS frame and/or the last BA frame), or triggered TXOP sharing can be used. An example of extending a TXOP by modifying the Duration field in a frame is illustrated in FIG. 8A, which shows the CTS with the modified duration and the BA with the modified duration. An example of extending a TXOP by triggered TXOP sharing is illustrated in FIG. 8B, which shows MU-RTS TXS trigger from an AP to the relay device and (MU-RTS TXS or Basic) trigger from the relay device to the non-AP STA. The relay device may retransmit a failed (A-) MPDU based on a 2^{nd} hop BA frame for the extended TXOP or for the allocated time duration in the same TXOP.

After receiving a forwarded beacon frame from the relay device 106, a non-UHR STA may perform association procedure with the relay device. The non-UHR STA that is associated with the relay device does not support reception of an end-to-end block acknowledgement frame sent from the relay device.

When a non-UHR STA is associated with the relay device 106, an end-to-end block acknowledgement (E2E BA) or an E2E Ack frame can be transmitted from the relay device to an AP for DL relay transmission, but it is not transmitted from the relay device to the non-UHR STA for UL relay transmission. For UL relay transmission, a non-UHR STA may retransmit a failed MPDU, to a relay device, based on a 1^{st} hop BA/Ack frame (not based on an E2E BA/Ack) within the same TXOP or a separate TXOP. In addition, the relay device may retransmit a failed MPDU to the AP based on the 2^{nd} hop BA/Ack frame within the same TXOP. Since the non-AP STA can retransmit a failed MPDU based on the 1^{st} hop BA/Ack frame within the same TXOP, in order to avoid collision between the retransmission of the 1^{st} hop frame from the non-AP STA and the transmission of the 2^{nd} hop frame from the relay device, the relay device may initiate the second hop frame transmission using a longer interframe space (IFS) (e.g., Point Coordination Function IFS (PIFS), Distributed Coordination Function (DIFS), or other IFS, etc.) only if no frame is detected from the non-AP STA during a certain time period (e.g. Short IFS+ (SIFS+), PIFS, etc.).

The non-AP STA can retransmit a failed MPDU based on the 1^{st} hop BA/Ack frame during the duration set in Duration field of the 1^{st} hop frame, and the Duration field of the 1^{st} hop BA/Ack frame can be set to a value extending the TXOP for the relay device 106 to forward the received frame to the AP with considering its retransmission. The relay device may transmit an E2E BA/Ack frame to an UHR STA for UL relay transmission.

For UL relay transmission, an UHR STA may retransmit a failed MPDU to the relay device 106 (1) based on a 1^{st} hop BA/Ack frame within the same TXOP, or (2) based on an E2E BA/Ack frame within a separate TXOP.

For UL relay with a non-UHR STA, the relay device 106 may extend a TXOP by modifying the Duration field in a frame (e.g., CTS frame and/or the last BA frame) for EDCA-based UL relay, or triggered TXOP sharing for trigger-based UL relay can be used.

The relay device 106 may retransmit a failed (A-) MPDU to the AP based on a 2^{nd} hop BA frame received from the AP for the extended TXOP or for the allocated time duration in the same TXOP.

The trigger-based UL relay can be applied to a UHR STA as well as a non-UHR STA. In order for the relay device to trigger non-AP STA's transmission, the Duration field in the MU-RTS TXS Trigger frame can be set to (1) a value covering the CTS (or CTS-to-self) transmission time, (2) a value covering the 2^{nd} MU-RTS TXS Trigger frame or the Basic Trigger frame, or (3) a value 0. The relay device 106 receiving the MU-RTS TXS Trigger frame from the AP may transmit another MU-RTS TXS Trigger frame or a Basic Trigger frame to a non-AP STA with or without sending a CTS (or a CTS-to-self) frame in response to the MU-RTS TXS Trigger frame. The 1^{st} MU-RTS TXS Trigger frame can include the following information: (1) non-AP STA's AID; (2) relay device's AID (can be included in the User Info field) or the MAC address (can be included in the RA field); (3) one or more allocation time-(a) if one allocation time is indicated, it is used for both 1^{st} hop and 2^{nd} hop transmission, or (b) if two allocation times are indicated, they are used for 1^{st} hop transmission and for 2^{nd} hop transmission, respectively. If the relay device does not receive/detect any UL Physical Layer Protocol Data Unit (PPDU) (e.g., any CTS, any non-trigger-based (non-TB)/trigger-based (TB) PPDU, etc.) from the non-AP STA in response to the 2^{nd} MU-RTS TXS Trigger frame or to the Basic Trigger frame, the relay device may return the allocation time to the AP by sending a quality of service (QOS) null frame indicating the allocation time release or a Contention Free (CF)-End frame.

In an embodiment, an RTS Announcement (RTSA) frame sent by the tSTA 102 (TXOP holder for relay operation) can trigger exchanging RTS/CTS frames among the rSTA(s) 106 and the dSTA 104. A CTS-ACK (or CTS) frame sent by rSTA(s) can be used for confirmation of protection signaling completion. A non-UHR STA does not generate the RTSA frame for UL relay TXOP protection. A non-UHR STA can transmit an RTS frame to a relay device to protect a TXOP for its uplink transmission.

In view of these observations, extended duration in the CTS frame can be used for TXOP protection for UL relay transmission. A non-UHR STA can transmit an RTS frame to the relay device 106 for TXOP protection. The relay device receiving the RTS frame can respond with a CTS frame. The CTS frame can include the extended duration value in the Duration field for 2^{nd} hop transmission for relay operation. It is noted here that a BA/Ack frame (sent from the relay device to the non-UHR STA) can include the extended duration value in the Duration field of the frame for relay device's 2^{nd} hop transmission to an AP. In addition, the relay device can retransmit a failed MPDU to the AP based on the 2nd hop BA/Ack frame within the same TXOP. An example of using extended duration in the CTS frame for TXOP protection for UL relay transmission in accordance with an embodiment of the invention is illustrated in FIG. 8A.

In an embodiment, triggered TXS can be used for TXOP protection for UL relay transmission. An AP can transmit a modified MU-RTS TXS Trigger frame to the relay device 106 that initiates a triggered TXS procedure (or a TB PPDU TX/RX) between the relay device and a non-AP STA for uplink relay transmission. The modified MU-RTS TXS Trigger frame can include an indication of triggered TXS (or a TB PPDU TX/RX) between the relay device and the non-AP STA for relay operation. The modified MU-RTS TXS Trigger frame can include the address information of the relay device and of the non-AP STA (e.g., MAC address, AID, etc.). The relay device receiving the modified MU-RTS TXS Trigger frame can transmit a MU-RTS TXS Trigger frame or a Trigger frame (e.g., basic Trigger frame, etc.) to the non-AP STA. Before transmitting the MU-RTS TXS Trigger frame or the basic Trigger frame, the relay device may transmit a CTS frame to the AP in response to the received modified MU-RTS TXS Trigger frame. The non-AP STA that receives the MU-RTS TXS Trigger frame may transmit to the relay device, e.g., a CTS frame and a non-TB PPDU, or the non-AP STA that receives a Trigger frame (e.g., basic Trigger, etc.) may transmit to the relay device, e.g., a TB PPDU. It is noted here that the relay device can retransmit a failed MPDU to the AP based on the 2^{nd} hop BA/Ack frame within the same TXOP. An example of using Triggered TXS for TXOP protection for UL relay transmission in accordance with an embodiment is illustrated in FIG. 8B.

Channel conditions of 1^{st} hop link and of 2^{nd} hop link can be different, so that sounding procedure can be done separately and independently for both links. Relay operation can be done within a single shared/extended TXOP initiated by an AP or by a non-AP STA so that the relay device 106 could flush all buffered data after the relay TXOP. The relay device may not be able to initiate a sounding sequence based on its queued traffic for 2^{nd} link channel parameter measurement/report within its own TXOP.

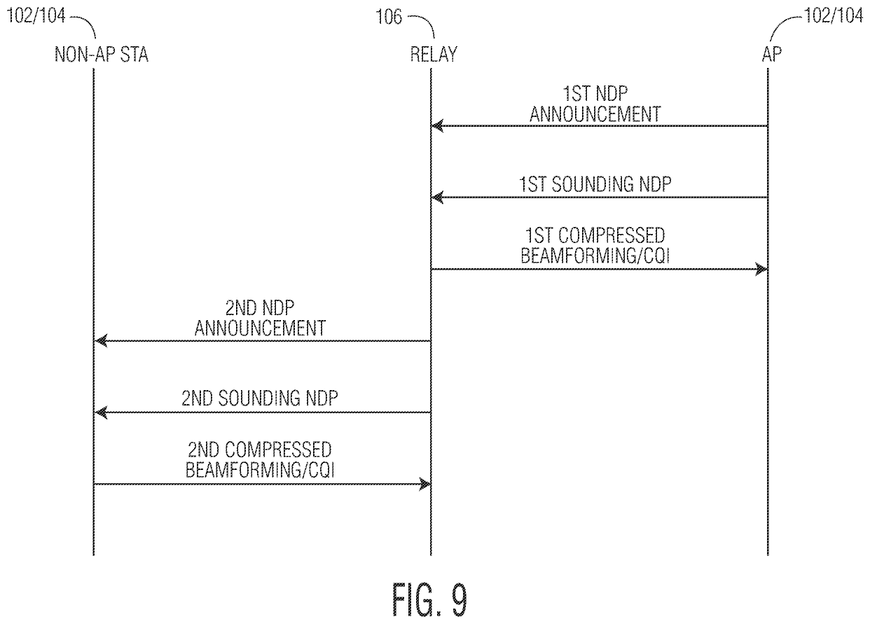

In view of these observations, cascaded sounding sequence for both 1^{st} hop link and 2^{nd} hop link can be done sequentially within a single shared/extended TXOP. An AP or a non-AP STA may initiate a cascaded sounding procedure for both 1^{st} hop link and 2^{nd} hop link. With this approach, (1) there would be TXOP protection for a two back-to-back sounding sequence, (2) the AP or the non-AP STA as a sounding initiator may indicate the cascaded sounding in a null data packet announcement (NDPA) frame, and (3) the relay device 106 may initiate the relay device to a destination device (e.g., a non-AP STA or an AP) sounding sequence based on the NDPA received from a source device (e.g., an AP or a non-AP STA). In an embodiment, the NDPA received from a source device can include an explicit indication and/or a destination device's address information (e.g., MAC address or AID). An example of a cascaded sounding sequence in accordance with an embodiment of the invention is illustrated in FIG. 9, which shows a first sounding sequence from the AP to the relay device and a second sounding sequence from the relay device to the non-AP STA.

If the relay device 106 intends to perform the cascade sounding procedure without receiving the cascade sounding indication in the 1^{st} NDPA frame, the relay device may transmit the 1^{st} compressed beamforming report frame with the Duration field set to the extended duration value covering the second hop sounding sequence. With a result of sounding for each link (1^{st} and 2^{nd} hop links), beamforming transmission can be done independently with a different set of spatial multiplexing (SM) matrices for each of the following links: (1) BFer/BFee between an AP and a relay device with a first set of SM matrices, and (2) BFer/BFee between a relay device and a non-AP STA with a second set to SM matrices.

When a relay link has been established and the transmitter device 102 (e.g., an AP or a non-AP STA) transmits a frame to the destination device 104 (e.g., a non-AP STA or an AP) through the relay device 106, the transmitter device may transmit more than one frames to the relay device in a TXOP. In addition, when the AP (or the non-AP STA) transmits more than one frame to the non-AP STA (or the AP) through the relay device, subsequent frames sent by the AP (or the non-AP STA) may be collided with frames forwarded by the relay device unless there is a rule about when the relay device forwards the received frame. Lastly, the frame may not solicit an acknowledgement frame (Ack Policy with No Ack) or solicit not an immediate response but a response later (Ack Policy with Block Ack).

In an embodiment, the relay device 106 may forward one or more received frames when it receives the last buffered frame from the transmitter device 102 (an AP or a non-AP STA). The last buffered frame can be indicated by the More Data field set to 0 in the MAC header of the received (A-) MPDU. The relay device does not forward any received frame immediately if it receives an (A-) MPDU with the More Data field set to 1 in the MAC header.

In an alternative embodiment, the relay device 106 may forward one or more received frame after sending an Ack or a BA frame if it receives (A-) MPDU with the Ack Policy Indicator set to 00 (e.g., Normal Ack or Implicit Block Acknowledgement Request (BAR)) or a management/action frame/control frame that solicit an Ack frame. The transmitter device may transmit more than one frames subsequently to the relay device without soliciting immediate response frames by setting the Ack Policy Indicator field set to 11 (Block Ack) in the QoS Control field in the transmitted (A-) MPDU. The last (A-) MPDU with the Ack Policy Indicator set to 00 (Implicit BAR) or a Block Ack Request (BAR) frame can be transmitted from the transmitter to the relay device so that the relay device can forward to the destination device (e.g., a non-AP STA) the (A-) MPDU successfully received from the transmitter device after responding with an BA frame (e.g., Compressed BA, Multi-STA BA, etc.).

In another alternative embodiment, the relay device 106 may forward a received frame based on an indication in the MAC header (e.g., A-Control field) of the received (A-) MPDU indicating whether or not the relay device needs to forward the received (A-) MPDU immediately, e.g., immediate relay or delayed relay, etc. If the immediate relay is indicated, the relay device may forward the successfully received frame (e.g., (A-) MSDU) immediately or right after transmitting the corresponding Ack or BlockAck frame. If the delayed relay is indicated, the relay device may not forward the successfully received frame with the delayed relay indication until it receives a frame indicating the immediate relay.

A TXOP holder (an AP or a non-AP STA) may transmit one or more QoS data frames with the Ack Policy set to “BlockAck” and it may transmit a BlockAck Request (BAR) frame after sending buffered MPDU(s) to a target recipient of the QoS data frames (a non-AP STA or an AP). When receiving the BAR frame from the TXOP holder, the relay device 106 may need to forward the BAR frame to the target recipient. However, the existing BAR frame cannot be relayed since it includes only the TA field and the RA field as the address information (i.e., no SA/DA field).

A modified BAR frame or a modified MU-BAR Trigger frame can include the SA field or the DA field. The BAR Type subfield of the BAR Control field can be set to a specific value indicating “Relay BAR”. Either a source address or a destination address can be included in the BAR Information field. The source address or the destination address can be an AID of a non-AP STA or an MAC address of a non-AP STA that is a transmitter of the BAR frame or a target recipient of the BAR frame.

In the baseline standard, an AP may transmit a MU-RTS TXS Trigger frame to allocate a time period to a non-AP STA for peer-to-peer transmission or for UL transmission using a non-TB PPDU. When a relay link is established for a non-AP STA, the non-AP STA may need to be allocated the time period for peer-to-peer transmission or for UL transmission by the MU-RTS TXS Trigger frame.

In order to address this need, an MU-RTS TXS Trigger frame may be relayed by an rSTA. For this solution, an assumption is that a relay link among an AP, a non-AP STA and the rSTA 106 has been established. In an embodiment, the MU-RTS TXS Trigger frame can be a modified MU-RTS Trigger frame. An AP may transmit a first MU-RTS TXS Trigger frame to a rSTA. The first MU-RTS TXS Trigger frame can include at least one of the followings: (1) a forward indication set to TRUE; (2) information of an rSTA's address; and (3) a dSTA's address. Examples include, but not limited to, (1) a TA field set to the AP's MAC address, and an RA field set to the rSTA's MAC address, and (2) an AID subfield in a User Info field set to a dSTA's AID.

The rSTA 106 that receives the first MU-RTS TXS Trigger frame may respond with a CTS frame to the AP when the medium is idle. The CTS frame transmission from the rSTA may be skipped when the AP can determine no error upon reception of a second MU-RTS TXS Trigger frame from the rSTA.

The rSTA 106 may transmit the second MU-RTS TXS Trigger frame to the dSTA 104. The second MU-RTS TXS Trigger frame can include at least one of the followings: (1) a forward indication set to FALSE, (2) information of a rSTA's address and (3) a dSTA's address. Examples include, but not limited to, (1) a TA field set to the rSTA's MAC address, and an RA field set to a broadcast address; and (2) an AID subfield in a User Info field set to a dSTA's AID. The dSTA that receives the second MU-RTS TXS Trigger frame may transmit a CTS frame to the rSTA when the medium is idle. The dSTA may use the time period allocated in the second MU-RTS TXS Trigger frame for peer-to-peer transmission or for relayed UL transmission through the rSTA.

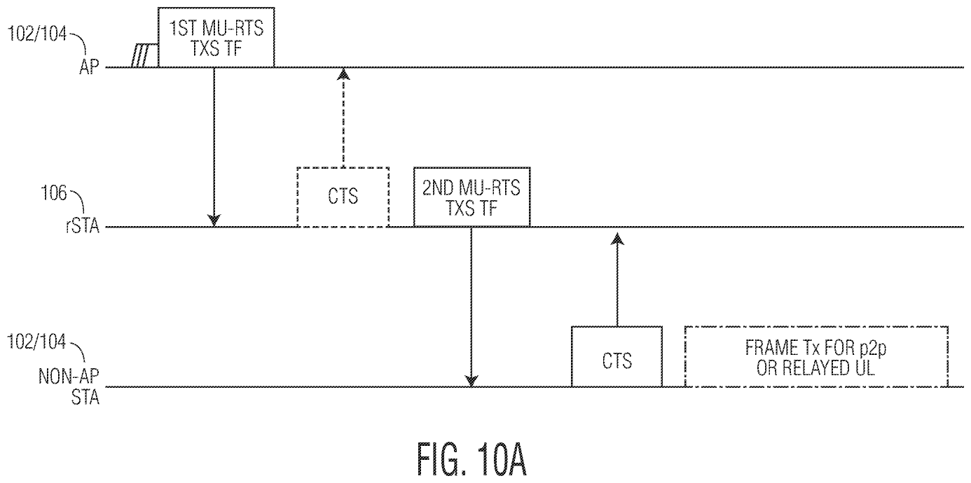

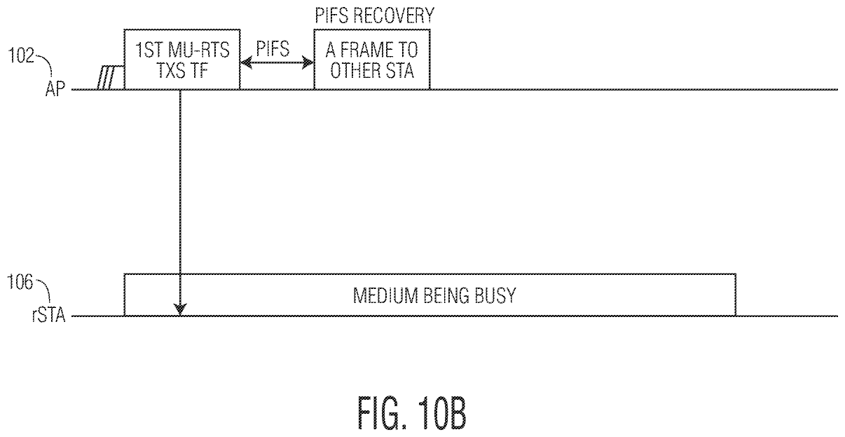

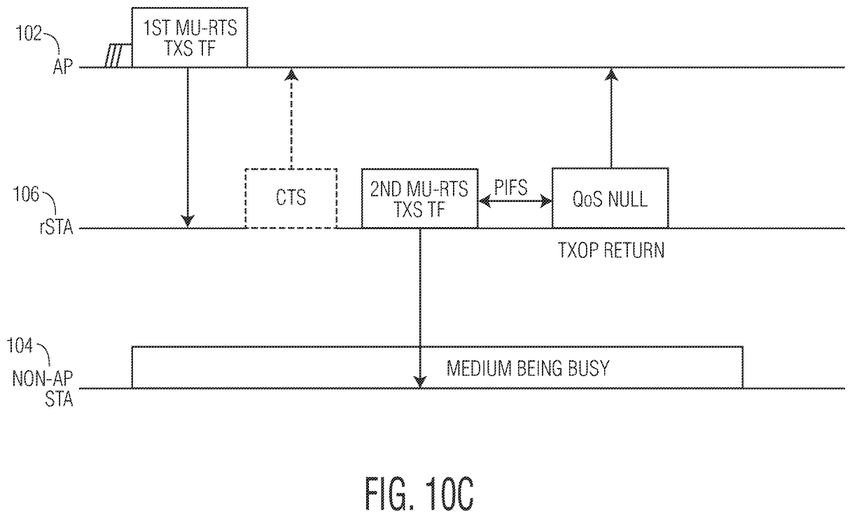

This is illustrated in FIG. 10A, which shows a CTS frame being transmitted from the rSTA 106 to the AP after the rSTA received the first MU-RTS TXS Trigger frame from the AP, and the second MU-RTS TXS Trigger frame being transmitted from the rSTA to the non-AP STA in accordance with an embodiment of the invention.

An rSTA that receives a first MU-RTS TXS Trigger frame does neither respond with a CTS frame to an AP nor transmit a second MU-RTS TXS Trigger frame to a dSTA when the medium is busy. Thus, when the AP determines the medium being idle at the TxPIFS slot boundary after transmission of the first MU-RTS TXS Trigger frame, the AP may perform a PIFS recovery or a backoff procedure. This is illustrated in FIG. 10B, which shows the AP performing a PIFS recovery or a backoff procedure in accordance with an embodiment of the invention.

A dSTA that receives a second MU-RTS TXS Trigger frame does not respond with a CTS frame to a rSTA when the medium is busy. Thus, when the rSTA determines the medium being idle at the transmit PIFS (TxPIFS) slot boundary after transmission of the second MU-RTS TXS Trigger frame, the rSTA may transmit to an AP a frame indicating the TXOP return (e.g., a QoS Null frame containing a CAS Control field with the RDG/More PPDU subfield equal to 0). This is illustrated in FIG. 10C, which shows a QoS Null frame being transmitted from the rSTA 106 to the AP in accordance with an embodiment of the invention.

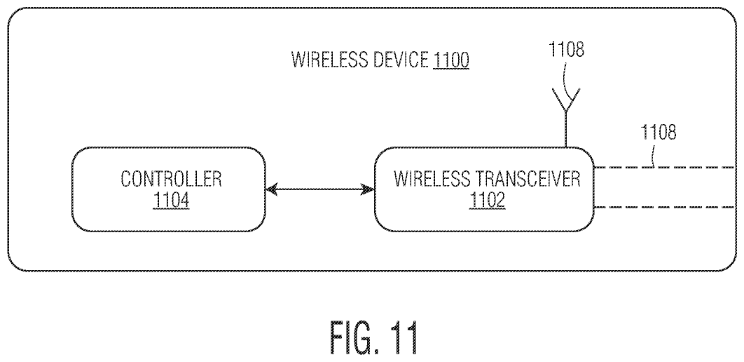

FIG. 11 depicts a wireless device 1100 in accordance with an embodiment of the invention. The wireless device 1100 can be used in the communications system 100 depicted in FIG. 1. For example, the wireless device 1100 may be an embodiment of the transmitter STA 102, the destination STA 104 or the relay STA 106 depicted in FIG. 1.

In the embodiment depicted in FIG. 11, the wireless device 1100 includes a wireless transceiver 1102, a controller 1104 operably connected to the wireless transceiver, and at least one antenna 1106 operably connected to the wireless transceiver. In some embodiments, the wireless device 1100 may include at least one optional network port 1108 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1100 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

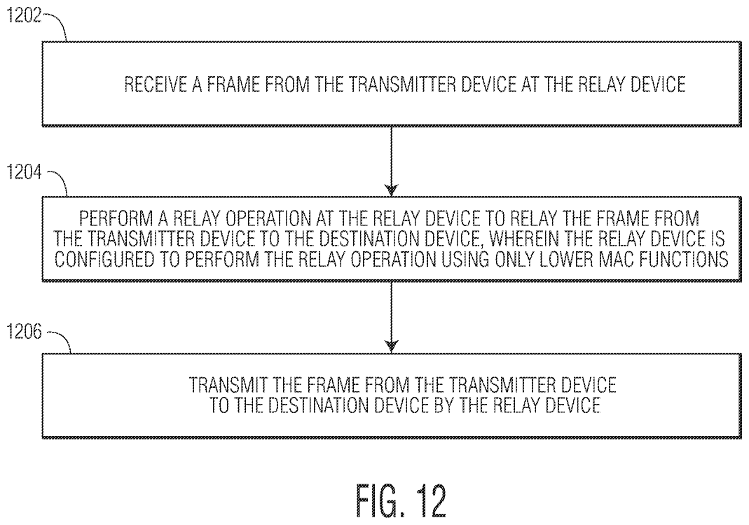

A method of relaying frames from a transmitter device to a destination device through a relay device in a communications system in accordance with an embodiment of the invention is described with reference to a flow diagram of FIG. 12. At block 1202, a frame from the transmitter device is received at the relay device. At block 1204, a relay operation is performed at the relay device to relay the frame from the transmitter device to the destination device, wherein the relay device is configured to perform the relay operation using only lower MAC functions. At block 1206, the frame from the transmitter device is transmitted to the destination device by the relay device.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A relay device comprising:
a wireless transceiver to receive and transmit frames; and
a controller operably coupled to the wireless transceiver to process the frames, wherein the controller is configured to:
receive a frame from the transmitter device;
perform a relay operation to relay the frame from the transmitter device to the destination device, wherein the relay device is configured to perform the relay operation using only lower MAC functions; and
transmit the frame from the transmitter device to the destination device.

2. The relay device of claim 1, wherein the controller is configured to:
transmit a first block acknowledgement frame to the transmitter device, wherein the first block acknowledgement frame includes a block ack information indicating which MAC protocol data unit (MPDU) is successfully received by the relay device; and
transmit a second frame to a destination device, wherein the second frame includes an MPDU based on at least one MPDU in the first frame that is successfully received from the relay device.

3. The relay device of claim 2, wherein the controller is further configured to:
receive a second block acknowledgement frame from the destination device, wherein the second block acknowledgement frame includes a block ack information indicating which MPDU of the second frame is successfully received by the destination device; and
transmit a third block acknowledgment frame to the transmitter device, wherein the third block acknowledgment frame includes a block ack information of the second block acknowledgement frame received from the destination device.

4. The relay device of claim 1, wherein the lower MAC functions include MAC protocol data unit (MPDU) processing and block acknowledgement processing, and the upper MAC functions include security processing, and sequence number and/or packet number processing.

5. The relay device of claim 1, wherein, for a downlink, an address information of the destination device is included in an additional MAC control header of the frame by the transmitter device, wherein the address information is an association identifier of the destination device and the additional MAC control header is an aggregated control field.

6. The relay device of claim 1, wherein, for an uplink, an address information of the transmitter device is included in an additional MAC control header of the frame by the relay device, wherein the address information is an association identifier of the transmitter device and the additional MAC control header is an aggregated control field.

7. The relay device of claim 1, wherein a time period is allocated to the relay device so that the controller can relay a frame to the destination device after receiving the frame from the transmitter device during the allocated time within a Transmit opportunity (TXOP).

8. The relay device of claim 1, wherein the controller is configured to receive, during a separate Transmit opportunity (TXOP), a retransmitted MAC protocol data unit (MPDU) that has not been successfully relayed to the destination device during a first TXOP.

9. The relay device of claim 1, wherein when the transmitter device is an ultra-high reliability (UHR) station and the destination device is an access point (AP), a MAC address of the AP is used to generate group keys, and when the transmitter device is a non-UHR station and the destination device is an AP, a MAC address of the relay device is used to generate group keys.

10. The relay device of claim 1, wherein the controller is configured to extend a Transmit opportunity (TXOP) by modifying a duration field in a frame or by using triggered TXOP sharing.

11. The relay device of claim 1, wherein the controller is configured to include an extended duration in a Request-to-Send (RTS) frame to the destination device for Transmit opportunity (TXOP) protection or use triggered TXOP sharing (TXS) for TXOP protection.

12. The relay device of claim 1, wherein the controller is configured to receive frames from the transmitter or destination device that has initiated a cascaded sounding procedure for a link between the transmitter device to the relay device or a link between the relay device and the destination device.

13. The relay device of claim 1, wherein, when the transmitter device transmits more than one frame to the relay device in a Transmit opportunity (TXOP), the controller forwards one or more of the received frames (a) when the relay device receives a last buffered from the transmitter device, (b) after sending an acknowledgement frame or a block acknowledgment frame, or (c) based on an indication in a MAC header.

14. The relay device of claim 1, wherein the controller is configured to receive, from the transmitter device, a modified block acknowledgement request (BAR) frame or a modified multi-user block acknowledgement request (MU-BAR) frame that includes a source address (SA) field or a destination address (DA) field.

15. The relay device of claim 1, where the controller is configured to relay a multi-user Request-to-Send (MU-RTS) triggered Transmit opportunity (TXOP) sharing (TXS) trigger frame to the destination device.

16. A method of relaying frames from a transmitter device to a destination device through a relay device, the method comprising:
receiving a frame from the transmitter device at the relay device;
performing a relay operation at the relay device to relay the frame from the transmitter device to the destination device, wherein the relay device is configured to perform the relay operation using only lower MAC functions; and
transmitting the frame from the transmitter device to the destination device by the relay device.

17. The method of claim 16, further comprising transmitting a first block acknowledgement frame to the transmitter device from the relay device, wherein the first block acknowledgement frame includes a block acknowledgement information indicating which MAC protocol data unit (MPDU) is successfully received by the relay device and wherein the frame transmitted to the destination device from the relay device includes an MPDU based on at least one MPDU in the frame that is successfully received from the relay device.

18. The method of claim 17, further comprising:
receiving a second block acknowledgement frame from the destination device at the relay device, wherein the second block acknowledgement frame includes a block acknowledgement information indicating which MPDU of the frame is successfully received by the destination device; and
transmitting a third block acknowledgment frame to the transmitter device, wherein the third block acknowledgment frame includes a block acknowledgement information of the second block acknowledgement frame received from the destination device.

19. The method of claim 16, wherein the lower MAC functions include MAC protocol data unit (MPDU) processing and block acknowledgement processing, and the upper MAC functions include security processing, and sequence number and/or packet number processing.

20. A communications system comprising:
a transmitter device configured to perform lower media access control (MAC) functions and upper MAC functions;
a destination device configured to perform the lower MAC functions and the upper MAC functions; and
a relay device operably coupled to the transmitter and destination devices, the relay device being configured to perform a relay operation to relay a first frame from the transmitter device to the destination device, wherein the relay device is configured to perform the relay operation using only the lower MAC functions.
